(19) United States
(12) Patent Application Publication
(10) Pub. No.: US 2003/0154489 A1
(43) Pub. Date: Aug. 14, 2003

(54) Method and system for separating static and dynamic data

(76) Inventors: Paul Finster, New York, NY (US); David Ruderman, Brooklyn, NY (US); David Ekhaus, Buffalo, NY (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/066,484

(22) Filed: Jan. 31, 2002

(51) Int. Cl. H04N 7/173

(52) U.S. Cl. 725/99

(57) ABSTRACT

A system and method for generating a grid for an electronic programming guide is described. One embodiment includes an electronic programming guide grid generator; a TV listings data module connected to the electronic programming guide generator; and a presentation module connected to the electronic programming guide grid generator.

### RELATED APPLICATIONS

The present application is related to commonly owned and assigned application nos.:

GIST-001/00US, entitled System and Method for Generating Customized EPG Data and EPG Application Programs;

GIST-003/00US, entitled Method and System for Optimal Grid Alignment; and

GIST-004/00US, entitled Method and System for Presentation of Pre-Generated Programming Information;

all of which are incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to electronic programming guides (EPGs). In particular, but not by way of limitation, the present invention relates to systems and methods for generating EPGs from dynamic and static data.

### BACKGROUND OF THE INVENTION

In recent years, entertainment program viewers have been provided with increasing numbers of viewing choices. For example, several cable television (“CATV”) providers now offer more than 100 channels of programming to their subscribers. Digital cable television providers offer more than 200 channels, and satellite television providers offer over 500 channels to their subscribers. The Internet and the increasing availability of broadband communications have introduced the availability of a practically unlimited number of sources of streaming video, representing an almost limitless diversity of content, from drama to sporting events to documentaries. Viewers can receive programming information via traditional print media or, for example, electronic programming guides (EPGs) that may be provided by a program provider directly through a television (“TV”) or a set-top box (STB) (e.g., an HTTP/HTML application, like a Web browser, than enables a TV to become a user interface to the Internet).

Although many web sites and cable providers offer an EPG to their viewers, few actually generate their own EPG. Rather, third party providers generate these EPGs for each web site/cable provider. Because each web site/cable provider needs a customized EPG, the EPG provider is forced to design and maintain customized EPGs for each web site/cable provider.

Most EPGs are somewhat similar in that they are generated by joining static HTML strings with dynamic TV listings data to form a grid display of TV listings data. Presently, this joining process is done on a grid cell by grid cell basis. In other words, each cell in the grid is formed by joining static HTML code, which defines the appearance and placement of a cell, with dynamic TV listings data for that individual cell. A large percentage of the code behind an EPG grid is static, repeated HTML code. Only a small percentage of the code actually represents the TV listings data.

These EPG systems that tend to generate EPG grids by joining the static HTML code with the dynamic TV listings data, in essence, “hardcode” the grid generation process. The EPG providers, thus, are required to create and maintain new EPG grid generation code for each client even though much of the basic grid generation code is the same. Accordingly, a system and method are needed that enables an EPG provider to efficiently generate customized EPG grids for different clients.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for separating the static structure of an EPG grid cell from the dynamic TV listings data (or other TV related data) that should be displayed therein. In one exemplary embodiment, the present invention can include a grid generator connected between a data module and a presentation module. The data module can contain the TV listings data—possibly divided by regions, cable providers, time zones, languages, etc. The presentation layer can include the instructions for identifying the proper TV listings data to be displayed in the grid. For example, the presentation layer can indicate that the EPG grid for ACME Cable Company should display only the program title, start time, and channel and that the data should be retrieved from the French language database. This indication of what data should be displayed in the EPG grid is called a “format string” and generally indicates a subset of the set of the TV listings data that is available in the data module.

When the grid generator generates an EPG grid for a specific client, e.g., such as a cable provider, it retrieves the format string for that client and retrieves the corresponding TV listings data from the data layer. This retrieved data is used to populate variable fields within the otherwise static grid-construction code. Thus, instead of hardcoding the TV listings data and the rendering instructions together, this embodiment of the present invention isolates the static structure of a grid cell and embeds within that static structure pointers to the appropriate TV listings data.

Accordingly, the present invention can provide for a substantial reduction in the volume of code needed to support multiple EPGs. Additionally, the present invention can provide for easy addition of new EPGs, such as for a new web site or cable company, and lower maintenance costs of existing EPGs. In fact, clients can actually modify, in real time, their EPG grid formats by modifying their format string. Prior systems, on the other hand generally require that the entire EPG code be recompiled and redeployed before a grid change could be implemented. Other embodiments of the present invention permits for easy integration of datasets with different dataset fields and different languages.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates one embodiment of a system for generating an EPG grid in accordance with the present invention;

FIG. 2 is a flowchart of one method for generating an EPG grid in accordance with the present invention; and

FIG. 3 illustrates an abstraction of three format strings.

### DETAILED DESCRIPTION

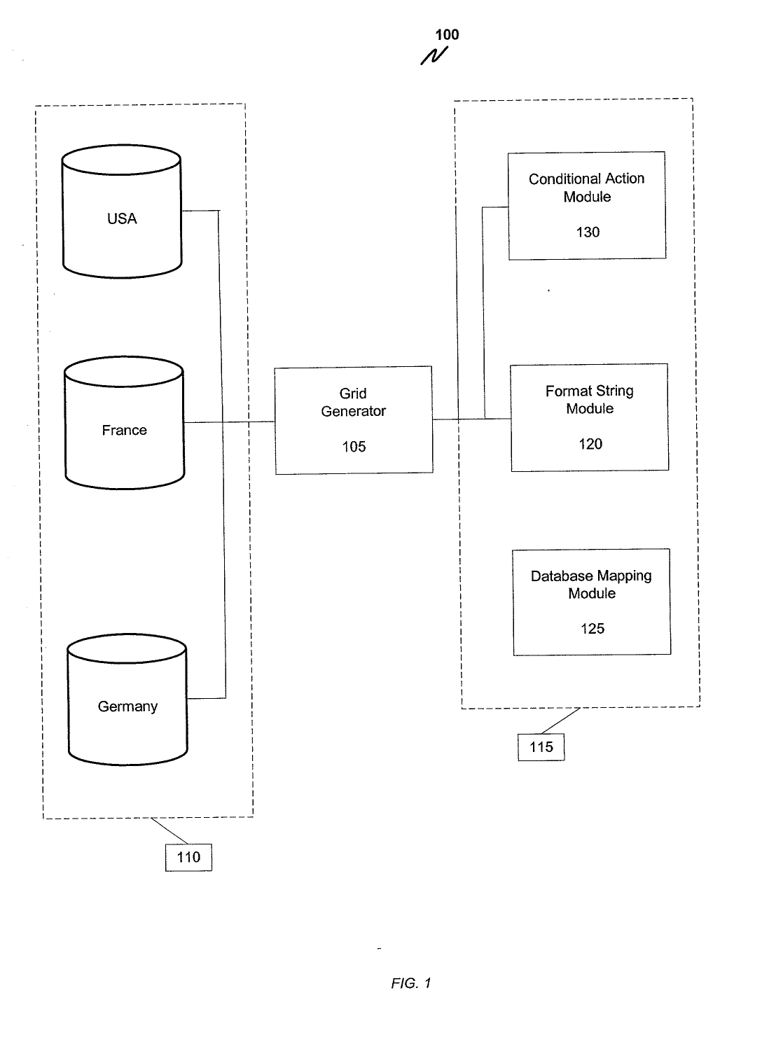

Referring now to the drawings, where like or similar elements are designated with identical reference numerals throughout the several views, and referring first to FIG. 1, it illustrates one embodiment of a system 100 constructed in accordance with the present invention. This embodiment includes a grid generator 105 coupled between a TV listings data module 110 and a presentation module 115. The grid generator 105 retrieves presentation instructions, e.g., a format string, from the presentation module 115 and TV listings data from the data module 115 and generates a customized EPG grid for a particular cable provider/web site.

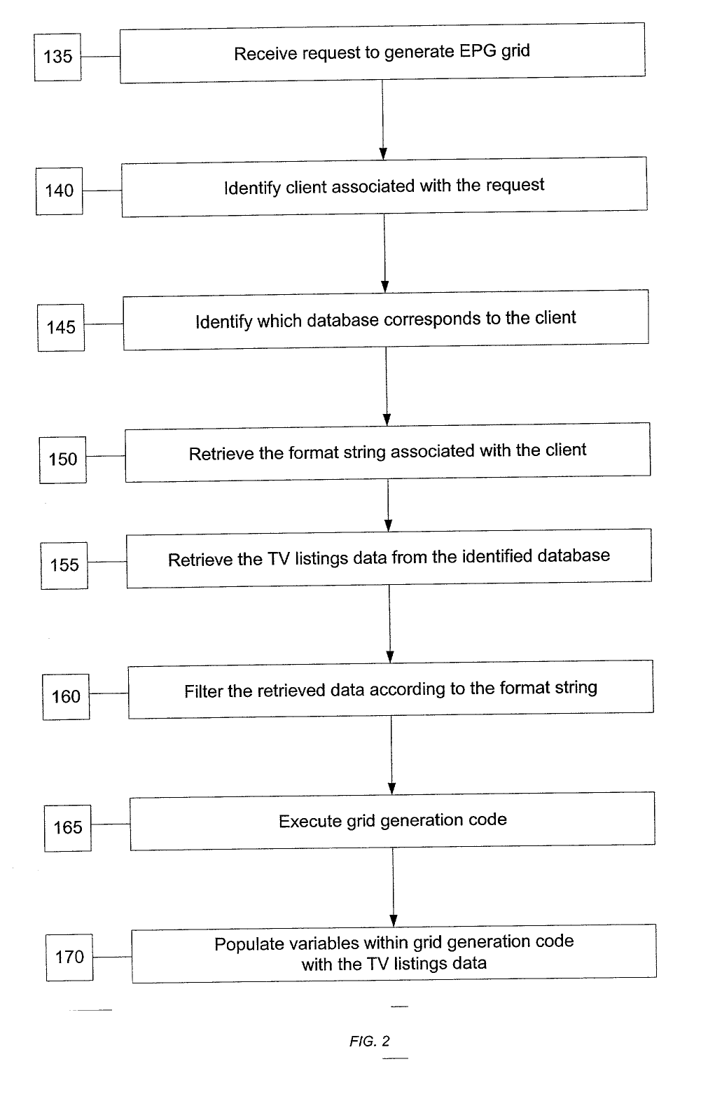

The operation of the system 100 of FIG. 1 is illustrated by the flowchart in FIG. 2. In this method of operation, the system 100 initially receives a request to generate an EPG grid (step 135). This request could come from an outside source such as a cable provider, a cable user possibly through a set-top box), or a web site host. Alternatively, the request could be generated local to the system 100 by an automated scheduler.

After receiving the request to generate the EPG grid, the EPG generator 105 identifies the client associated with the request (step 140). Using the identity of the client, the grid generator 105 could determine which database, e.g., French language, English language, etc., is associated with the client and/or request (step 145). For example, a web portal may be offered in several languages. Thus, an EPG grid for the portal would need to be displayed in each of those languages. Otherwise, the portals would need to maintain a similar format. Before the grid generator 105 could generate the appropriate grid, it would need to know both the identity of the web portal and the correct language (indicated in the request) for the TV listings data. Using the client identity and/or the language information, the grid generator 105 can select the correct database, e.g., the French language database, from which to retrieve the TV listings data. In addition to dividing the TV listings data by language, the TV listings data can be divided by region, time zone, cable provider, country, etc.

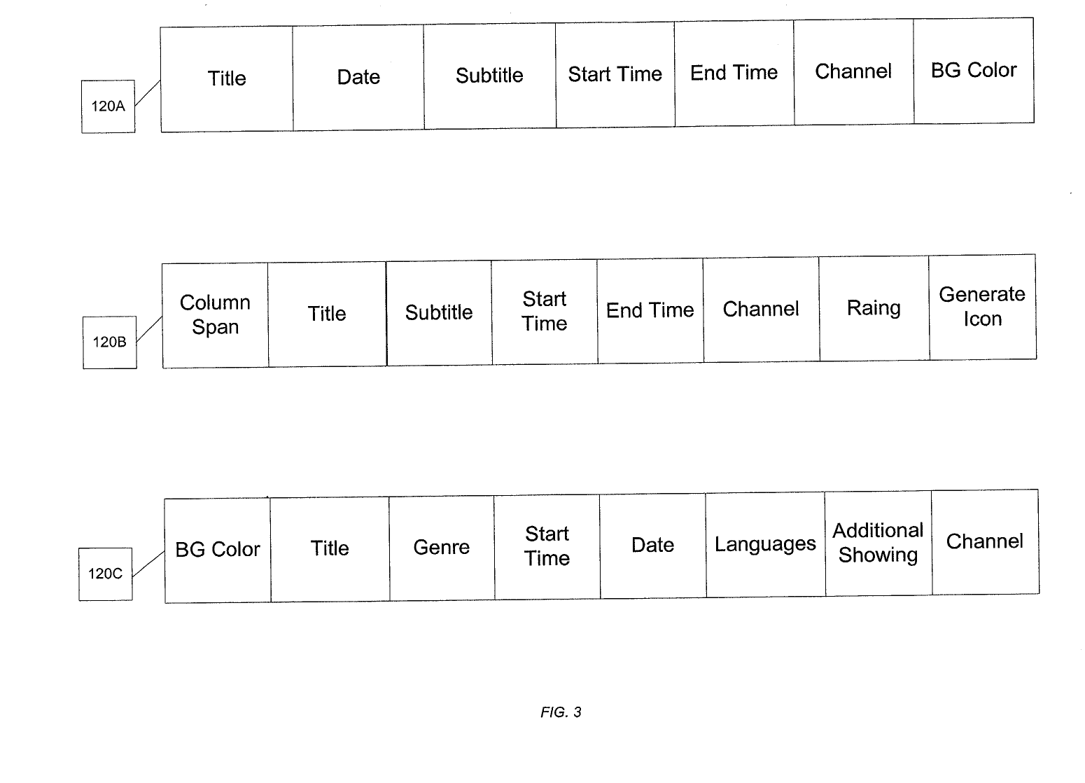

Still referring to FIG. 2, the grid generator 105 next accesses the format string module in the presentation module 115 and retrieves the appropriate format string from the format string module 120 (step 150). The format string module 120 includes format strings associated with particular clients. Each of the format strings includes a list of attributes that the client wants displayed in its EPG grid. For example, a format string could include the attributes “column span,” “title,” “background,” “color,” “start time,” “stop time,” etc. FIG. 3 illustrates an abstraction of three different format strings 120A, 120B, 120C, and a Java version of a format string can be illustrated by:

{<td colspan=%COLSPAN%}
{bgcolor=%BGCOLOR%>
{<a href=\”%PROJECT%%HREF%pid=%PID%&cid=
CID%&GID=%gid%&u

=%U%&gmt=%GMT%\”>}

{<font size=2>%TITLE%</font></a></td>}.

In the above Java code, the string “%COLSPAN%” is a placeholder for dynamic data as opposed to the static “td colspan=.” In this embodiment, the “%” symbols indicate variables—although any symbol could be used. For every generated grid cell, the “%COLSPAN%” would be replaced with the actual value retrieved from the data module.

After the grid generator 105 retrieves the format string, the attributes of the format string are mapped against the structure of the appropriate database in the TV listings data module 110. The instructions for mapping the format string against the structure of the appropriate database can be found in the database mapping module 125, which can include, for example, schema information about the databases included in the TV listings data module 110. In other embodiments, the database mapping module 125 includes a map that associates the attributes of a format string with the fields in each of the databases.

Using the format string and the schema information, the grid generator 105 can access the correct database within the TV listings data module 110 and retrieve the TV listings data that corresponds to the client (step 155). The grid generator 105 can then parse the data and associate the attributes in the format string with the values in the retrieved TV listing data to thereby form TV listings attribute-value pairs used to process the format string (step 160). Alternatively, the grid generator 105 can retrieve only the values from the TV listings data that correspond to the attributes in the client's format string. Next, the grid generator 105 can generate the EPG grid by populating variables in the grid generation code with the TV listings data (steps 165 and 170).

An example of Java code for building grid cells using the format string is shown below.

protected String buildVisibleGridCell (Hashtable p,
String row[], boolean

addlinks, GenreMapping gm) throws GAttributeException

{

| | |
|---|---|
| 1 | StringBuffer buf = new StringBuffer ( ) ; |
| 2 | int colspan = 0 ; |
| 3 | int progmin = getAttributeAsInt (p, CELLTHRESHOLD) ; |
| 4 | int dim = getDBDataAsInt (row,_DIM) ; |
| 5 | int delta1 = getDBDataAsInt (row,_DELTA1) ; |
| 6 | int delta2 = getDBDataAsInt (row,_DELTA2) ; |
| 7 | int gridwidth = getDBDataAsInt |
| | (row,_GRIDWIDTHFROMDB) ; |
| 8 | |
| 9 | String alignment = null ; |
| 10 | String background = null ; |
| 11 | |
| 12 | boolean spansleftpost = (getDBDataAsInt |
| | (row,_SPANSLEFTPOST) > 0) ; |
| 13 | boolean spansrightpost = (getDBDataAsInt |
| | (row,_SPANSRIGHTPOST) > 0) ; |
| 14 | |
| 15 | String link = null ; |
| 16 | GDateTime gd = new GDateTime |
| | (GDateTime.datebaseTimeToUniversal |
| 17 | row[_UNIVERSALTIME])) ; |
| 18 | int gmtoffset = getAttributeAsInt(p, GMTOFFSET) ; |
| 19 | gd.add (java.util.Calendar.HOUR, gmtoffset) ; |
| 20 | |
| 21 | colspan = calculateColspan (spansleftpost, spansrightpost, |
| | dim, gridwidth, |
| 22 | delta1, delta2) ; |
| 23 | buf.append (openDataCellTag ( ) ) ; |
| 24 | buf.append (GConstants.BLANKSPACE) ; |
| 25 | |
| 26 | // put ′attributes′ hashtable in proper state |
| 27 | p.put (“COLSPAN”, Integer.toString(colspan)) |
| 28 | p.put (“U”, gd.getUniversalDateTime( )) |
| 29 | |
| 30 | if (!getAttributeAsBoolean (p, USECOLOR)) ; |

| | |
|---|---|
| 31 | { |

| | |
|---|---|
| 32 | deleteAttribute(p, “BGCOLOR”) |

| | |
|---|---|
| 33 | } |
| 34 | |

| | |
|---|---|
| 35 | return cellformat.expand (p, row) ; |

| | |
|---|---|
| 36 | } |

Referring to the above grid generation code, the hashtable ‘p’ is actually the name of a ‘repository’ in memory of attribute/value pairs. ‘Values’ can be retrieved, updated, and deleted based on accessing them using their ‘key’. The string array ‘row’ contains all the data retrieved from the database for the current program. The data is referred to as the ‘Attribute Namespace’ or ‘Namespace’. As a grid is being built there can be two distinct sets of data: the data that does not change from one grid cell to another and the data that does. Both types of data are stored in the Namespace.

The method in the above code retrieves data from the Namespace to construct the grid cells. For example, on line 3 the call to “getAttributeAsInt” is looking up the value of a Namespace attribute called ‘CELLTHRESHOLD’ that was previously put in the Namespace. The method in this code also calculates and adds to the Namespace two keys: COLSPAN and U. The “COLSPAN” is a grid cells' “Column Span” and is the number of minutes that appear in that grid cell “U” is the start date and time in universal format of that program, e.g., yyyymmddhhmm.

Still referring to FIG. 2, the grid generator 105 can next populate the TV listing variables in the grid generation code with the appropriate TV listing data retrieved from the data module 110. This step in the above code is represented by the last line “return cellformat.expand (p, row).” The final generated grid will include cells that contain the value corresponding to the attributes in the format string and that are shaded according to the values corresponding to attributes in the format string.

To clarify, consider the example where the following format string is processed by the above grid-generation code

| | |
|---|---|
| 1 | { <td colspan=%COLSPAN% } |
| 2 | { bgcolor=%BGCOLOR%> } |
| 3 | { <a href=\ “%PROJECT%%HREF%pid=%PID%&cid= |
| | %CID%&gid=%GID%&u=%U%&gmt=%GMT%\ ” > } |
| 4 | { <font size=2>%TITLE% </font></a></td> } |

and the data module (Namespace) contains the following values

| | |
|---|---|
| %COLSPAN% | = 30 |
| %BGCOLOR% | = abcdef |
| %PROJECT% | = /tv |
| %HREF% | = /progdesc.jsp? |
| %PID% | = EP2724220558 |
| %CID% | = 11953 |
| %GID% | = 36 |
| %U% | = 200101051100 |
| %GMT% | = −5 |
| %TITLE% | = The Jerry Springer Show. |

The result of processing the format string can be represented by:

<td colspan=30 bgcolor=abcdef
<a ref = “/tv/progdesc.jsp?pid=EP2724220558&cid=
11953&gid=36&u=200101051100&gmt=−5”>
<font size=2>The Jerry Springer Show</font></a></td>

In a further embodiment of the present invention, TV listing attributes can be linked to executable code executed or initiated by the conditional action module 130. For example, the format string described with relation to FIGS. 1 and 3 could be configured to include an indication of executable code. Format string 120B in FIG. 3 shows such a link as “Generate Icon.” The conditional access module 130 can be loaded or updated at run-time.

The code tied to the “Generate Icon” attribute could, for example, determine the rating for the program and display a lock—indicating a parental control lock—if the rating is “R” or above. In another embodiment, the “Generate Icon” attribute could be linked to code that generates a Pay Per View (PPV) icon. The code could also include intructions for billing the viewer when a PPV program is selected. One example of a format string with an embedded link can be represented by

| | |
|---|---|
| 1 | { <td colspan=%COLSPAN% } |
| 2 | { bgcolor=%BGCOLOR%> } |
| 3 | { <a href=\“%PROJECT%%HREF%pid=%PID%&cid= |
| | %CID%&gid=%GID%&u=%U%&gmt=%GMT%\ ”> } |
| 4 | { <font size=2> } |
| 5 | { [ColspanTest] } |
| 6 | {</font></a></td>} |

The relevant code appears in line 5 as “[ColspanTest]”. The left and right square braces are used to indicate that the enclosed string is to be interpreted as a “CompiledExpression.” The Java code for the ‘ColspanTest’ CompiledExpression could be:

public class ColspanTest implements ExpressionPlugin
{

/** This is our start function */
public String doWork (Hashtable attributehash, String dbdata [])
throws

GAttributeException

{

| | |
|---|---|
| int cellthreshhold | = Grid.getAttributeAsInt(attributehash, |
| | Grid.CELLTHRESHOLD) ; |
| int colspan | = Grid.getAttributeAsInt(attributehash, |
| | “COLSPAN”) ; |

if (colspan < cellthreshhold)
{

return “isn't this cool”;

}
else
{

return Grid.getAttributeAsString (a, “TITLE”)

}

}

}

In conclusion, the present invention provides, among other things, a system and method for generating EPGs from dynamic and static data. Those skilled in the art can readily recognize that numerous variations and substitutions may be made in the invention, its use and its configuration to achieve substantially the same results as achieved by the embodiments described herein. For example, the present invention can operate with alternatives to HTML and Java. Accordingly, there is no intention to limit the invention to the disclosed exemplary forms. Many variations, modifications and alternative constructions fall within the scope and spirit of the disclosed invention as expressed in the claims.

What is claimed is:

1. A method for generating a cell within an electronic programming guide grid; the method comprising:
identifying a client associated with the electronic programming guide grid;
retrieving a format string associated with the client;
retrieving a plurality of TV listings data items;
identifying the matching data items in the plurality of TV listings data items, wherein the matching data items comprise at least one of the plurality of TV listings data items that correspond to the retrieved format string; and
generating the cell using the matching data items.

2. The method of claim 1, wherein the client comprises a cable provider.

3. The method of claim 1, wherein the client comprises a web site host.

4. The method of claim 1, wherein the format string comprises:
data identifiers and format indicators.

5. The method of claim 4, wherein the format indicators comprise:
color indicators.

6. The method of claim 1, wherein the format string and the plurality of TV listings data items are stored separately.

7. The method of claim 1, further comprising:
receiving a request to generate an electronic programming guide grid.

8. The method of claim 7, wherein receiving a request comprises:
receiving a request from an automatic scheduler.

9. The method of claim 1, further comprising:
identifying a TV listings data set associated with the client.

10. The method of claim 9, wherein the TV listings data set is one of a plurality of TV listings data sets and wherein the plurality of TV listings data sets are categorized by language.

11. The method of claim 9, wherein the TV listings data set is one of a plurality of TV listings data sets and wherein the plurality of TV listings data sets are categorized by cable provider.

12. The method of claim 1, wherein the format string comprises:
a link to an executable action item.

13. The method of claim 1, wherein generating the cell comprises:
generating a display structure for the cell; and
inserting the matching data items into the display structure for the cell.

14. The method of claim 1, wherein generating the cell comprises:
executing grid generation code; and
populating variables within the grid generation code with the matching data items.

15. The method of claim 9, further comprising:
identifying a TV listings data set associated with the client; and
retrieving a schema for the TV listings data set, wherein the schema can be used to correlate the format string and the TV listings data set.

16. A device for generating a grid for an electronic programming guide, the device comprising:
an electronic programming guide grid generator;
a TV listings data module connected to the electronic programming guide generator; and
a presentation module connected to the electronic programming guide grid generator.

17. The device of claim 16, wherein the TV listings data module comprises:
a plurality of data sets organized by category.

18. The device of claim 17, wherein the category comprises one of:
regions, cable providers, and languages.

19. The device of claim 16, wherein the presentation module comprises:
a format string module comprising a plurality of format strings.

20. The device of claim 19, wherein the presentation module comprises:
a conditional action module configured to execute actions responsive to a processed one of the plurality of format strings including an executable action indicator.

21. The device of claim 19, wherein the presentation module comprises:
a mapping module.

22. The device of claim 21, wherein the TV listings data module comprises:
a plurality of data sets;
and wherein the mapping module comprises:
a plurality of schema for correlating the plurality of format strings with corresponding ones of the plurality of data sets.

23. A system for generating a cell within an electronic programming guide grid; the system comprising:
means for identifying a client associated with the electronic programming guide grid;
means for retrieving a format string associated with the client;
means for retrieving a plurality of TV listings data items;
means for identifying the matching data items in the plurality of TV listings data items, wherein the matching data items comprise at least one of the plurality of TV listings data items that correspond to the retrieved format string; and
means for generating the cell using the matching data items.

24. A method for generating a cell within an electronic programming guide grid; the method comprising:
retrieving a format string;
retrieving a plurality of TV listings data items;
identifying the matching data items in the plurality of TV listings data items, wherein the matching data items comprise at least one of the plurality of TV listings data items that correspond to the retrieved format string; and
generating the cell using the matching data items.

25. A method for generating a cell within an electronic programming guide grid; the method comprising:
retrieving a format string;
identifying a plurality of matching data items in a plurality of TV listings data items, wherein the plurality of matching data items comprise at least one of the plurality of TV listings data items that correspond to the retrieved format string;
retrieving the identified plurality of matching data items; and
generating the cell using the matching data items.
